(19) United States
(12) Patent Application Publication
(10) Pub. No.: US 2020/0133048 A1
(43) Pub. Date: Apr. 30, 2020

(54) POLYIMIDE FILM

(71) Applicant: UBE INDUSTRIES, LTD., Ube-shi (JP)

(72) Inventors: Takuya OKA, Ube-shi (JP); Miharu NAKAGAWA, Ube-shi (JP); Nobuharu HISANO, Ube-shi (JP)

(21) Appl. No.: 16/343,910

(22) PCT Filed: May 30, 2018
(86) PCT No.: PCT/JP2018/020805

§ 371 Date: Apr. 22, 2019

(30) Foreign Application Priority Data
May 31, 2017 (JP) 2017-108158

(51) Int. Cl. G02F 1/1333; C08G 73/10; C08J 5/18

(52) U.S. Cl. CPC G02F 1/133305; C08G 73/1078; C08J 2379/08; C08J 5/18; C08G 73/1032

(57) ABSTRACT

A polyimide film having, when measured at a film thickness of 10 μm, a weight residue ratio of 99.0% or more when held at 400° C. for 4 hours, a YI (yellow index) of 10 or less, and a coefficient of linear thermal expansion between 100 and 350° C. of 55 ppm/K or less. The polyimide film is excellent in transparency and heat resistance, has a low linear thermal expansion coefficient, and can be suitably used for a substrate for a display, a touch panel, or a solar cell.

### TECHNICAL FIELD

The present invention relates to a polyimide film, and a substrate for a display, a touch panel, or a solar cell.

### BACKGROUND ART

In recent years, along with the arrival of an advanced information society, developments are progressing for optical materials, such as optical fibers and optical waveguides in the field of optical communication and liquid crystal alignment films and protective films for color filters in the field of display devices. Especially in the field of display devices, active studies are made on plastic substrates which are light weight and excellent in flexibility as substitutes for glass substrates, and also active developments are carried out on displays capable of bending and rolling. For this reason, optical materials having higher performance that can be used for such applications are required.

As plastic substrates to replace glass substrates, many polyimide films have been proposed (for example, see Patent Documents 1 to 3). However, since various properties are required for a substrate of a display device, further improvement of the proposed polyimide film has been demanded.

In addition to substrates, studies have also been made on plastic cover sheets (protective films) as a substitute for cover glass for protecting display surfaces. However, also as a cover sheet (protective film) on a display surface, the conventional polyimide film has room for further improvement.

### CITATION LIST

### Patent Document

Patent Document 1: WO 2013/069725

Patent Document 2: Published Japanese Translation No. 2010-538103

Patent Document 3: Japanese Patent Laid-Open No. 2017-82225

### SUMMARY OF THE INVENTION

### Technical Problem

The purpose of the present invention is to provide a polyimide film which can be suitably used for various applications such as a substrate for a display, a touch panel, or a solar cell, and specifically, a polyimide film which is excellent in transparency and heat resistance and also has a low coefficient of linear thermal expansion.

### Solution to Problem

The present invention relates to the following items.

1. A polyimide film comprising polyimide, having:
when measured at a film thickness of 10 μm, weight residue ratio of 99.0% or more when held at 400° C. for 4 hours, YI (yellow index) of 10 or less, and
coefficient of linear thermal expansion between 100 and 350° C. of 55 ppm/K or less.
   2. The polyimide film according to the above item 1, having weight residue ratio of 99.0% or more when held at 430° C. for 1 hour when measured at a film thickness of 10 μm.
   3. The polyimide film according to the above item 1 or 2, having coefficient of linear thermal expansion between 100 and 380° C. of 65 ppm/K or less when measured at a film thickness of 10 μm.
   4. The polyimide film according to any one of the above items 1 to 3, having haze of 2% or less when measured at a film thickness of 10 μm.
   5. The polyimide film according to any one of the above items 1 to 4, having retardation in thickness direction (Rth) of 1000 nm or less when measured at a film thickness of 10 μm.
   6. The polyimide film according to any one of the above items 1 to 5, having light transmittance at a wavelength of 308 nm of 0.1% or less when measured at a film thickness of 10 μm.
   7. A laminate, comprising the polyimide film according to any one of the above items 1 to 6 that has been formed on a glass substrate.
   8. A substrate for a display, a touch panel, or a solar cell, comprising the polyimide film according to any one of the above items 1 to 6.

### Effect of the Invention

According to the present invention, provided is a polyimide film having excellent transparency, heat resistance, and low coefficient of linear thermal expansion, and in particular, a polyimide film which can be suitably used as a substrate for a display, a touch panel, or a solar cell.

The polyimide film of the present invention can be suitably used for various purposes in addition to a substrate, and can be suitably used, for example, as a cover sheet for protecting a display surface of displays.

### BRIEF DESCRIPTION OF THE DRAWINGS

FIG. 1 is a diagram (TGA chart) showing a measurement result of weight residue ratio of a polyimide film of Example 2 when held at 400° C. for 4 hours.

### DESCRIPTION OF EMBODIMENTS

The polyimide film of the present invention is a film comprising polyimide. Here, the polyimide means a polymer containing repeating unit(s) having an imide structure, and also includes polyamide imide, polyether imide, polyester imide and the like.

The polyimide film of the present invention has weight residue ratio of 99.0% or more, preferably 99.1% or more, more preferably 99.2% or more, particularly preferably 99.3% or more % when held at 400° C. for 4 hours when measured at a film thickness of 10 μm. Further, the weight residue ratio when held at 430° C. for 1 hour is preferably 99.0% or more when measured at a film thickness of 10 μm. When a polyimide film is used for a display substrate or the like, a conductive layer is formed on the surface of the polyimide film, and a transistor is formed. The polyimide film can withstand this high-temperature manufacturing process and thus, a thin film transistor with good characteristics can be obtained, if the polyimide film has weight residue ratio of 99.0% or more, particularly preferably 99.3% or more % when held at 400° C. for 4 hours when measured at a film thickness of 10 μm, and furthermore, if the polyimide film also has weight residue ratio of 99.0% or more when held at 430° C. for 1 hour when measured at a film thickness of 10 μm. In addition, it is possible to prevent contamination of manufacturing facilities due to decomposition of polyimide. In order to be applied to a wide range of manufacturing processes and in order to manufacture thin film transistors with better characteristics while preventing contamination of manufacturing facilities, a polyimide film may be, in some cases, particularly desired to have weight residue ratio of 99.3% or more % when held at 400° C. for 4 hours when measured at a film thickness of 10 μm.

In the present invention, “the weight residue ratio when held at 400° C. for 4 hours” and “the weight residue ratio when held at 430° C. for 1 hour” are the values measured for a sample having weight (total weight) of 4 mg. The weight change may be measured by heating at 400° C. for 4 hours, or 430° C. for 1 hour for a sample where a plurality of polyimide films with a film thickness of 10 μm are stacked.

The weight residue ratio after holding at 400° C. for 4 hours and the weight residue after holding at 430° C. for 1 hour tend to decrease as the film thickness decreases.

The polyimide film of the present invention has YI (yellow index) of 10 or less, preferably 9 or less, more preferably 8 or less, more preferably 7 or less, more preferably 6 or less, particularly preferably 5 or less, when measured at a film thickness of 10 μm. When a polyimide film is used for light transmitting purposes such as a display substrate, the polyimide film is required to have transparency, more accurately, colorless (achromatic) transparency. The smaller absolute value of YI (yellowness) means that the film is closer to colorless (achromatic). When YI is 10 or less, particularly preferably 5 or less, when measured at a film thickness of 10 μm, the required colorlessness can usually be secured. YI tends to increase as the film thickness increases. In addition, YI is preferably 0 or more.

From the viewpoint of transparency, the light transmittance of the polyimide film of the present invention at a wavelength of 400 nm when measured at a film thickness of 10 μm is preferably 70% or more, more preferably 72% or more, more preferably 74% or more, and particularly preferably 75% or more. Further, in the polyimide film of the present invention, the total light transmittance (average light transmittance in the wavelength range from 380 nm to 780 nm) when measured at a film thickness of 10 μm is preferably 70% or more, more preferably 75% or more, and more preferably 80% or more, more preferably 82% or more, and particularly preferably 84% or more. The light transmittance at a wavelength of 400 nm and also the total light transmittance tend to decrease as the film thickness increases.

The polyimide film of the present invention has coefficient of linear thermal expansion between 100 and 350° C. of 55 ppm/K or less, preferably 50 ppm/K or less, particularly preferably 45 ppm/K or less, when measured at a film thickness of 10 μm. In one embodiment, it is preferable that the coefficient of linear thermal expansion between 100 and 350° C. measured at a film thickness of 10 μm is even lower, and is more preferably 40 ppm/K or less, more preferably 35 ppm/K or less, particularly preferably 30 ppm/K or less, or less than 30 ppm/K. When a polyimide film is used for a display substrate or the like, a conductive layer is formed on the surface of the polyimide film, and a transistor is formed. If the coefficient of linear thermal expansion of the polyimide film is large within the temperature range of the manufacturing process, the difference in coefficient of linear thermal expansion between the polyimide film and a conductor such as a metal becomes large, which may cause problems such as an increase in warpage of the substrate. In order to obtain a thin film transistor having satisfactory characteristics without any problem by a usual manufacturing process, at least the coefficient of linear thermal expansion between 100 and 350° C. measured at a film thickness of 10 μm is required to be 55 ppm/K or less, particularly preferably 40 ppm/K or less.

Further, in order to be applied to a wider manufacturing process, the polyimide film has low linear thermal expansion coefficient preferably up to a higher temperature. Specifically, the linear thermal expansion coefficient between 100 to 380° C., more preferably 100 to 390° C., more preferably 100 to 400° C., more preferably 100 to 410° C., particularly preferably 100 to 420° C., when measured at a film thickness of 10 μm, is preferably 65 ppm/K or less, more preferably 60 ppm/K or less, more preferably 55 ppm/K or less, more preferably 50 ppm/K or less, particularly preferably 45 ppm/K or less. In one embodiment, the linear thermal expansion coefficient between 100 to 380° C., more preferably 100 to 390° C., more preferably 100 to 400° C., more preferably 100 to 410° C., particularly preferably 100 to 420° C., when measured at a film thickness of 10 μm, is preferably 40 ppm/K or less, more preferably 35 ppm/K or less, particularly preferably 30 ppm/K or less, or preferably less than 30 ppm/K.

In one embodiment, it is preferable that the coefficient of linear thermal expansion between 100 and 430° C. when measured at a film thickness of 10 μm is 65 ppm/K or less. Furthermore, it is sometimes preferable that the coefficient of linear thermal expansion between 100 and 430° C. when measured at a film thickness of 10 μm is 60 ppm/K or less, more preferably 55 ppm/K or less.

The above linear thermal expansion coefficient of the polyimide film of the present invention is a value measured for a polyimide film having a film thickness of 10 μm under a condition that the film width is 4 mm, the distance between chucks is 15 mm, the tensile load is 2 g, and the heating rate is 20° C./min. Here, the coefficient of linear thermal expansion tends to decrease as the film thickness increases.

The polyimide film of the present invention, when measured at a film thickness of 10 μm, preferably has haze of 2% or less, more preferably 1.5% or less. When a polyimide film is used for display applications or the like, if the haze thereof is high, the light may be scattered and the image may be blurred. Usually, such a problem can be prevented if the haze is 2% or less when measured at a film thickness of 10 μm. The haze tends to increase as the film thickness increases.

The polyimide film of the present invention preferably has retardation in thickness direction (Rth) of 1000 nm or less, more preferably 850 nm or less, and more preferably 830 nm or less when measured at a film thickness of 10 μm. When a polyimide film is used for a display application or the like, the larger retardation in the thickness direction may cause such problems that the color of the transmitted light may not be displayed correctly, the color looks blurred and the viewing angle may be narrowed. The retardation in thickness direction (Rth) tends to increase as the film thickness increases.

Further, the polyimide film of the present invention preferably has light transmittance at a wavelength of 308 nm of 0.1% or less, more preferably 0.05% or less, when measured at a film thickness of 10 μm. In many production processes of devices in which a polyimide film is used as a substrate or the like, a varnish of a polyimide precursor (a composition containing a polyimide precursor) or a varnish of a polyimide (a composition containing a polyimide) is flow-casted on a base such as a glass, and heated to obtain a polyimide/base laminate, which is then irradiated with laser light (wavelength: 308 nm) from the substrate (glass) surface to peel off the polyimide film from the base. If the polyimide film has high light transmittance at a wavelength of 308 nm and does not absorb energy of light of 308 nm wavelength (laser light), the polyimide film cannot be peeled from the base. In order to be applied to a process including a step of peeling a polyimide film from a base with a laser, it is necessary that the light transmittance at a wavelength of 308 nm is low, preferably 0.1% or less, when measured at a film thickness of 10 μm. The light transmittance at a wavelength of 308 nm tends to decrease as the film thickness increases.

If the physical property values as mentioned above are satisfied, such polyimide films are obtained that can be suitably used particularly for a substrate for a display, and also that can be suitably used for a substrate for a touch panel or a substrate for a solar cell and the like.

Details of the method of measuring the above physical property values will be described in Examples below.

The polyimide film of the present invention is not limited to those having a thickness of 10 μm. The thickness of the polyimide film is appropriately selected depending on the application, and is usually 1 to 250 μm, more preferably 1 to 150 μm, more preferably 1 to 50 μm, particularly preferably 1 to 30 μm.

If necessary, the polyimide film of the present invention may contain fillers (inorganic particles or organic particles such as silica), antioxidants, ultraviolet absorbers, dyes, pigments, coupling agents such as silane coupling agents, primers, flame retardants, leveling agents, release agents, other various additives commonly used in polyimide films, and the like.

In one embodiment, it is preferred that the polyimide film of the present invention does not contain inorganic particles such as silica or organic particles (filler) in view of film strength and smoothness of the film surface, or from the viewpoint of ease of production and cost.

The polyimide film of the present invention may be formed of, for example, a polyimide which comprises repeating units represented by the following chemical formula (1-1) in an amount of 50 mol % or more, preferably 60 mol % or more, more preferably 70 mol % or more, based on the total amount of repeating units.

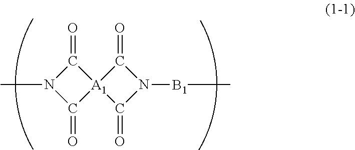

(In the formula, A₁ is a tetravalent group represented by the following chemical formula (A-1), B₁ is a divalent group represented by the following chemical formula (B-1).)

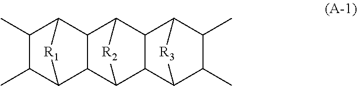

(In the formula, R₁, R₂, R₃ are each independently —CH₂— or —CH₂CH₂—.)

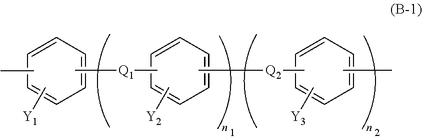

(In the formula, n₁ represents an integer of 0 to 3, and n₂ represents an integer of 0 to 3. Y₁, Y₂ and Y₃ each independently represent one selected from the group consisting of a hydrogen atom, a methyl group and a trifluoromethyl group, and Q₁ and Q₂ each independently represent a direct bond or one selected from the group consisting of groups represented by formulae: —NHCO—, —CONH—, —COO—, and —OCO—.)

The polyimide film of the present invention may also be formed of, for example, a polyimide which comprises repeating units represented by the following chemical formula (1-2) in an amount of 50 mol % or more, preferably 60 mol % or more, more preferably 70 mol % or more, based on the total amount of repeating units.

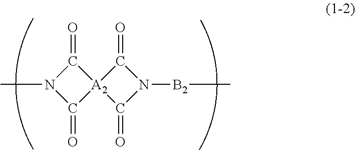

(In the formula, A₂ is a tetravalent group represented by the following chemical formula (A-2), B₂ is a divalent group represented by the following chemical formula (B-1).)

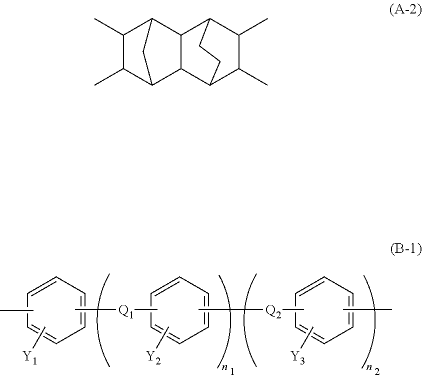

(In the formula, n₁ represents an integer of 0 to 3, and n₂ represents an integer of 0 to 3. Y₁, Y₂ and Y₃ each independently represent one selected from the group consisting of a hydrogen atom, a methyl group and a trifluoromethyl group, and Q₁ and Q₂ each independently represent a direct bond or one selected from the group consisting of groups represented by formulae: —NHCO—, —CONH—, —COO—, and —OCO—.)

In the group represented by the chemical formula (B-1), the bonding position between the aromatic rings is not particularly limited, but they are preferably bonded at the 4-position to the imide group ((—CO—)₂N—) which is bonded to A₁ or A₂ or to the linking group between the aromatic rings. By bonding in this way, the obtained polyimide has a linear structure, which may sometimes provide low linear thermal expansion. When the group represented by the chemical formula (B-1) has one aromatic ring (in the case that n₁ and n₂ are 0), the group represented by the chemical formula (B-1) is preferably a p-phenylene group which may have a substituent (Y₁). Further, the aromatic ring may be substituted with a methyl group or a trifluoromethyl group, but the substitution position thereof is not particularly limited.

Examples of the divalent group represented by the chemical formula (B-1) include groups represented by any one of the following chemical formulae (B-1-1) to (B-1-6).

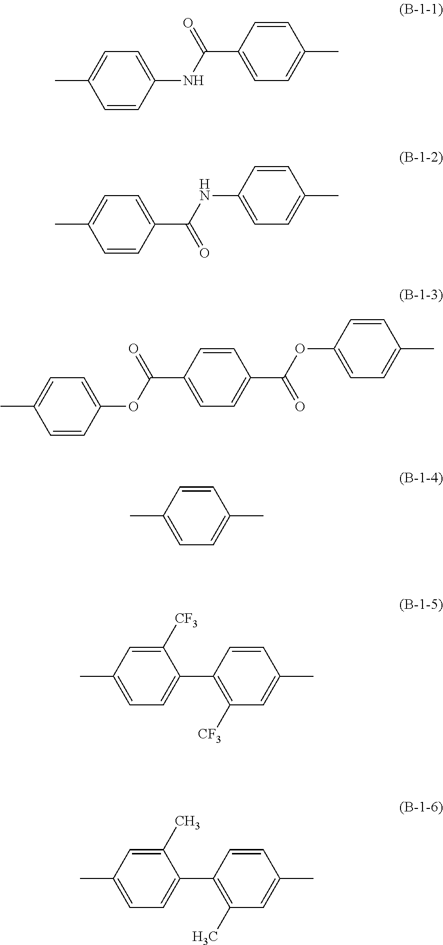

Further, the polyimide film of the present invention may be formed of a polyimide which comprise, for example, repeating units represented by the chemical formula (1-1) or (1-2) in an amount of, for example, 60 mol % or more, preferably 65 mol % or more, more preferably 70 mol % or more, alternatively 75 mol % or more, alternatively 80 mol % or more, alternatively 90 mol % or more, based on the total amount of repeating units, wherein, the polyimide comprises one or more of repeating unit in which the tetravalent group derived from a tetracarboxylic acid component is a tetravalent group represented by the chemical formula (A-1) or (A-2), and the divalent group derived from a diamine component has a plurality of aromatic rings linked with an ether bond (—O—), in an amount of, for example, 40 mol % or less, preferably 35 mol % or less, more preferably 30 mol % or less, alternatively 25 mol % or less, alternatively 20 mol % or less, alternatively 10 mol % or less, based on the total amount of repeating units. In this case, usually, the polyimide preferably comprises the repeating unit in which the tetravalent group derived from a tetracarboxylic acid component is a tetravalent group represented by the chemical formula (A-1) or (A-2), and the divalent group derived from a diamine component has a plurality of aromatic rings linked with an ether bond (—O—), in an amount of 5 mol % or more, based on the total amount of repeating units.

Examples of the divalent group having a plurality of aromatic rings in which some or all of the aromatic rings are linked by an ether bond (—O—) include groups represented by the following chemical formulae (B-2-1) to (B-2-4).

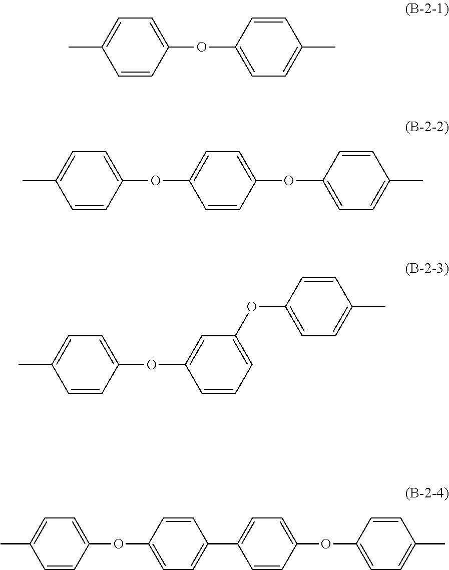

However, the polyimide film of the present invention is not limited to those composed of these polyimides.

Examples of the tetracarboxylic acid component that can be suitably used to obtain the polyimide constituting the polyimide film of the present invention include derivatives of tetradecahydro-1H, 3H-4, 12:5, 11:6, 10-trimethanoanthra[2,3-c:6,7-c′]difuran-1,3,7,9-tetraone, decahydro-1H, 3H-4, 10-ethano-5,9-methanonaphtho[2,3-c: 6,7-c′]difuran-1,3,6,8-tetraone, 2,2-bis(3,4-dicarboxyphenyl) hexafluoropropane, pyromellitic acid, 3,3′,4,4′-benzophenonetetracarboxylic acid, 3,3′,4,4′-biphenyltetracarboxylic acid, 2,3,3′,4′-biphenyltetracarboxylic acid, 4,4′-oxydiphthalic acid, bis(3,4-dicarboxyphenyl) sulfone dianhydride, m-terphenyl-3,4,3′,4′-tetracarboxylic dianhydride, p-terphenyl-3,4,3′,4′-tetracarboxylic dianhydride, 1,2,3,4-cyclobutanetetracarboxylic acid, cyclohexane-1,2,4,5-tetracarboxylic acid, bicyclo[2.2.2]octane-2,3,5,6-tetracarboxylic acid, 9-oxatricyclo[4.2.1.0 2,5]nonane-3,4,7,8-tetracarboxylic acid, decahydro-1,4:5,8-dimethanonaphthalene-2,3,6,7-tetracarboxylic acid, norbornane-2-spiro-a-cyclopentanone-α′-spiro-2″-norbornane-5,5″,6,6″-tetracarboxylic acid, and the like, or the dianhydrides of these. Examples of other tetracarboxylic acid components that can be used include, for example, derivatives of 3a,4,10,10a-tetrahydro-1H,3H-4,10-methanonaphtho[2,3-c:6,7-c′]difuran-1,3,6,8-tetraone, 3a,4,6,6a,9a, 10,12,12a-ooctahydro-1H,3H-4,12:6,10-dimethanoanthra[2,3-c:6,7-c′]difuran-1,3,7,9-tetraone, 4-(2,5-dioxotetrahydrofuran-3-yl)-1,2,3,4-tetrahydronaphthalene-1,2-dicarboxylic acid, biscarboxyphenyldimethylsilane, bisdicarboxyphenoxydiphenyl sulfide, sulfonyl diphthalic acid, isopropylidenediphenoxybisphthalic acid, [1,1′-bi(cyclohexane)]-3,3′,4,4′-tetracarboxylic acid, [1,1′-bi(cyclohexane)]-2,3,3′,4′-tetracarboxylic acid, [1,1′-bi(cyclohexane)]-2,2′,3,3′-tetracarboxylic acid, 4,4′-methylenebis(cyclohexane-1,2-dicarboxylic acid), 4,4′-(propane-2,2-diyl) bis(cyclohexane-1,2-dicarboxylic acid), 4,4′-oxybis(cyclohexane-1,2-dicarboxylic acid), 4,4′-thiobis(cyclohexane-1,2-dicarboxylic acid), 4,4′-sulfonyl bis(cyclohexane-1,2-dicarboxylic acid), 4,4′-(dimethylsilanediyl) bis(cyclohexane-1,2-dicarboxylic acid), 4,4′-(tetrafluoropropane-2,2-diyl) bis(cyclohexane-1,2-dicarboxylic acid), octahydropentalene-1,3,4,6-tetracarboxylic acid, bicyclo[2.2.1]heptane-2,3,5,6-tetracarboxylic acid, 6-(carboxymethyl) bicyclo[2.2.1]heptane-2,3,5-tricarboxylic acid, bicyclo[2.2.2]oct-5-ene-2,3,7,8-tetracarboxylic acid, tricyclo[4.2.2.0 2,5]decane-3,4,7,8-tetracarboxylic acid, tricyclo[4.2.2.02,5]dec-7-ene-3,4,9,10-tetracarboxylic acid, and the like or dianhydrides of these. These tetracarboxylic acid components (tetracarboxylic acids and the like) may be used alone or in combination of two or more of these. Here, the tetracarboxylic acid component (tetracarboxylic acids or the like) refers to a tetracarboxylic acid and a tetracarboxylic acid derivative such as tetracarboxylic acid dianhydride, tetracarboxylic acid silyl ester, tetracarboxylic acid ester, tetracarboxylic acid chloride and the like.

Examples of the diamine component usable for obtaining the polyimide constituting the polyimide film of the present invention include p-phenylenediamine, m-phenylenediamine, benzidine, 3,3′-diamino-biphenyl, 2,2′-bis(trifluoromethyl) benzidine, 3,3′-bis(trifluoromethyl) benzidine, m-tolidine, 4,4′-diaminobenzanilide, 3,4′-diaminobenzanilide, N, N′-bis(4-aminophenyl) terephthalamide, N, N′-p-phenylenebis(p-aminobenzamide), 4-aminophenoxy-4-diaminobenzoate, bis(4-aminophenyl) terephthalate, biphenyl-4,4′-dicarboxylic acid bis(4-aminophenyl) ester, p-phenylene bis(p-aminobenzoate), bis(4-aminophenyl)-[1,1′-biphenyl]-4,4′-dicarboxylate, [1,1′-biphenyl]-4,4′-diylbis(4-aminobenzoate), 1,4-diaminocyclohexane, 1,4-diamino-2-methylcyclohexane, 1,4-diamino-2-ethylcyclohexane, 1,4-diamino-2-n-propylcyclohexane, 1,4-diamino-2-isopropylcyclohexane, 1,4-diamino-2-n-butylcyclohexane, 1,4-diamino-2-isobutylcyclohexane, 1,4-diamino-2-sec-butylcyclohexane, 1,4-diamino-2-tert-butylcyclohexane, 1,2-diaminocyclohexane, 4,4′-oxydianiline, 3,4′-oxydianiline, 3,3′-oxydianiline, bis(4-aminophenyl) sulfide, p-methylenebis(phenylenediamine), 1,3-bis(4-aminophenoxy) benzene, 1,3-bis(3-aminophenoxy) benzene, 1,4-bis(4-aminophenoxy) benzene, 2,2-bis[4-(4-aminophenoxy) phenyl]hexafluoropropane, 2,2-bis(4-aminophenyl) hexafluoropropane, bis(4-aminophenyl) sulfone, 3,3-bis((aminophenoxy) phenyl) propane, 2,2-bis(3-amino-4-hydroxyphenyl) hexafluoropropane, bis(4-(4-aminophenoxy) diphenyl) sulfone, bis(4-(3-aminophenoxy) diphenyl) sulfone, octafluorobenzidine, 3,3′-dimethoxy-4,4′-diaminobiphenyl, 3,3′-dichloro-4,4′-diaminobiphenyl, 3,3′-difluoro-4,4′-diaminobiphenyl, 9,9-bis(4-aminophenyl) fluorene, 4,4′-bis(4-aminophenoxy) biphenyl, 4,4′-bis(3-aminophenoxy) biphenyl, and the like. These diamine components may be used alone or in combination of two or more of these.

Examples of a process for manufacturing a polyimide film generally include:

(1) a process comprising flow-casting, on a support in a form of film, a polyimide precursor solution or a polyimide precursor solution composition containing, as necessary, additives selected from an imidization catalyst, a dehydrating agent, a release assisting agent and inorganic fine particles in a polyimide precursor solution, drying the film by heating to give a self-supporting film, and then heating it for cyclodehydration and for desolvation to give a polyimide film;
(2) a process comprising flow-casting, on a support in a form of film, a polyimide precursor solution composition prepared by adding a cyclization catalyst and a dehydrating agent and a further selected additive, as necessary, such as inorganic fine particles to a polyimide precursor solution; then chemically cyclodehydrating it and, as necessary, drying it by heating to give a self-supporting film, which is then heated for desolvation and imidization to give a polyimide film;
(3) when a polyimide is soluble in an organic solvent, a process comprising flow-casting, on a support in a form of film, a polyimide solution composition containing selected additives such as a release assisting agent and inorganic fine particles, drying by heating it to partially or completely remove a solvent, and then heating it to a maximum heating temperature to give a polyimide film; and
(4) when a polyimide is soluble in an organic solvent, a process for producing a polyimide film by flow-casting, on a support in a form of film, a polyimide solution composition containing selected additives such as a release assisting agent and inorganic fine particles, heating the film to a maximum heating temperature while a solvent is removed, to give a polyimide film.

Polyimides which are insoluble in organic solvents may be preferable in applications requiring solvent resistance and chemical resistance. Preparation of the polyimide film which are insoluble in organic solvents is generally carried out by a method via a polyimide precursor solution or a polyimide precursor solution composition, that is, the above methods (1) and (2).

The polyimide precursor may be classified to 1) a polyamide acid (also called as polyamic acid), 2) a polyamide acid ester (at least a part of H of the carboxyl group of the polyamide acid is an alkyl group), and 3) a polyamide acid silyl ester (at least a part of H of the carboxyl group is an alkylsilyl group).

These polyimide precursors can be produced from a tetracarboxylic acid component and a diamine component which give the above polyimide structure. For example, a polyimide precursor solution composition can be obtained by reacting a tetracarboxylic acid component (a tetracarboxylic acid dianhydride and the like) and a diamine component in almost equal moles, preferably in a molar ratio of the diamine component to the tetracarboxylic acid component [diamine component mole number to tetracarboxylic acid component mole number] of preferably 0.90 to 1.10, and more preferably 0.95 to 1.05, in a solvent at a relatively low temperature such as 120° C. or less to suppress the imidization.

An example of a method for producing a polyimide film include, for example, a method comprising casting a polyimide precursor composition on a base material and heating the polyimide precursor composition on the base material at about, for example, 100 to 500° C., preferably 200 to 500° C., more preferably 250 to 450° C., to imidize the polyimide precursor while removing the solvent. The heating profile is not particularly limited and may be selected appropriately.

Further, a polyimide film may also be suitably produced by casting a polyimide precursor composition on a base material, drying it preferably at a temperature range of 180° C. or lower to form a film of the polyimide precursor composition on the base material, peeling the film of the polyimide precursor composition from the base material, heating it while fixing the end portion of the film or not fixing the end portion of the film at about, for example, 100 to 500° C., preferably 200 to 500° C., more preferably 250 to 450° C., to imidize the polyimide precursor.

Further, a polyimide film may be suitably produced by casting a polyimide solution composition containing a polyimide on a base material, and heating it at about, for example, 80 to 500° C., preferably 100 to 500° C., more preferably 150 to 450° C., to removing the solvent. Also in this case, the heating profile is not particularly limited and may be selected appropriately.

As the base material, glass is usually preferable, and a polyimide film/glass-base laminate in which a polyimide film is formed on a glass base material is suitably used for manufacturing, for example, a display substrate.

On one side or both sides of the polyimide film/base laminate or the polyimide film obtained as described above, a conductive layer may be formed to obtain a flexible conductive substrate.

A flexible conductive substrate may be obtained by the following methods, for example. As for the first method, the polyimide film is not peeled from the base material in the “polyimide film/base” laminate, and a conductive layer of a conductive material (metal or metal oxide, conductive organic material, conductive carbon, or the like) is formed on the surface of the polyimide film by sputtering, vapor deposition, printing, or the like, to provide a “conductive layer/polyimide film/base” conductive laminate. Thereafter, as necessary, the “electrically-conductive layer/polyimide film” laminate is peeled from the base material, to provide a flexible conductive substrate which includes the “conductive layer/polyimide film” laminate.

In manufacturing a flexible device using a polyimide film/glass base laminate, in addition to a conductive layer, a semiconductor layer and/or a dielectric layer may be formed on a polyimide film of the laminate to form a device element and a circuit necessary for the device. In the case of manufacturing a TFT liquid crystal display device, for example, an amorphous silicon TFT is formed on the polyimide film. The TFT comprises, for example, a gate metal layer, a semiconductor layer such as an amorphous silicon film, a silicon nitride gate dielectric layer, and ITO pixel electrode. Further on the film, structures necessary for a liquid crystal display may be formed by a known method. After forming the necessary device elements and circuits for the device on the polyimide film and further forming the main structure of the device such as the liquid crystal display, the glass base is peeled off. The peeling method is not particularly limited, and peeling may be performed by irradiating a laser or the like, for example, from the glass base side.

As for the second method, the polyimide film is peeled from the base material in the “polyimide film/base” laminate to obtain the polyimide film, and then a conductive layer of a conductive material (metal or metal oxide, conductive organic material, conductive carbon, or the like) is formed on the surface of the polyimide film in the same way as in the first method, to provide a flexible conductive substrate which includes the “conductive layer/polyimide film” laminate, or the “conductive layer/polyimide film/conductive layer” laminate.

In the first and second methods, if necessary, before forming the conductive layer on the surface of the polyimide film, inorganic layer(s), for examples, a barrier layer to gas such as water vapor, oxygen or the like, and a light controlling layer may be formed by sputtering, vapor deposition or gel-sol method.

As for the conductive layer, a circuit may be suitably formed by a method such as a photolithography method, various printing methods, an inkjet method, or the like.

The substrate of the present invention thus obtained has a circuit of a conductive layer on the surface of a polyimide film formed of the polyimide of the present invention, if necessary, via a gas barrier layer or an inorganic layer. This substrate can be suitably used as a substrate for a display, a touch panel, or a solar cell.

That is, a transistor (inorganic transistor, organic transistor) may be further formed on this substrate by vapor deposition, various printing methods, ink jet method or the like to manufacture a flexible thin film transistor, and is suitably used as a liquid crystal element, an EL element, and a photovoltaic element.

### EXAMPLE

The present invention will be more specifically described by the following Examples and Comparative Examples. However, the present invention is not limited to the following examples.

In the following examples, the evaluation was carried out by the following method.

<Evaluation of Polyimide Film>

[YI]

YI of a polyimide film having a film thickness of 10 μm and a size of 5 cm square was measured in accordance with the ASTEM E313 standard using a UV/visible spectrophotometer/V-650DS (manufactured by JASCO Corporation). The light source was D65 and the viewing angle was 2°.

[Light Transmittance at 400 nm, Light Transmittance at 308 nm, Total Light Transmittance]

The light transmittance at a wavelength of 400 nm, the light transmittance at a wavelength of 308 nm, the total light transmittance (average transmission from 380 nm to 780 nm) of a polyimide film with a film thickness of 10 μm and a size of 5 cm square was measured using a UV/visible spectrophotometer/V-650DS (manufactured by JASCO Corporation).

[Hase]

Haze of a polyimide film having a film thickness of 10 μm and a size of 5 cm square was measured in accordance with the standard of JIS K7136 using a turbidimeter/NDH 2000 (manufactured by Nippon Denshoku Industries Co., Ltd.).

[Weight Residue Ratio after Holding at 400° C. for 4 Hours]

A polyimide film having a film thickness of 10 μm was cut into a size of about 6 mm square to prepare a test piece. The sample weight was adjusted to 4 mg by stacking several cut test pieces, and using a thermogravimetric apparatus (Q 5000 IR) manufactured by TA Instruments, the sample was heat-treated in nitrogen flow with the program of maintaining at 200° C. for 30 minutes, raising from 200° C. to 400° C. at a heating rate of 100° C./min and maintaining for 4 hours. The weight when the temperature reached 400° C. was taken as 100%, and the weight residue ratio after 4 hours was determined.

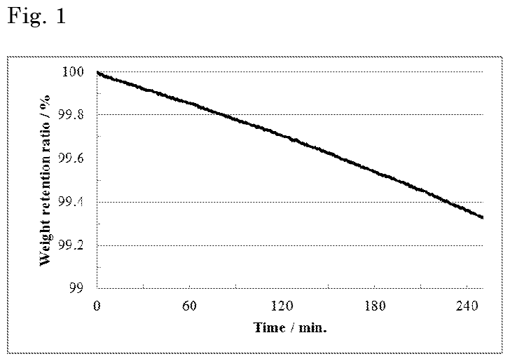

FIG. 1 shows a measurement result (TGA chart) of weight residue ratio of a polyimide film of Example 2 when held at 400° C. for 4 hours. For the polyimide films of Example 1 and Comparative Examples 1 to 3, the weight residue ratio was measured with the same high precision.

[Weight Residue Ratio after Holding at 430° C. for 1 Hour]

A polyimide film having a film thickness of 10 μm was cut into a size of about 6 mm square to prepare a test piece. The sample weight was adjusted to 4 mg by stacking several cut test pieces, and using a thermogravimetric apparatus (Q 5000 IR) manufactured by TA Instruments, the sample was heat-treated in nitrogen flow with the program of maintaining at 200° C. for 30 minutes, raising from 200° C. to 430° C. at a heating rate of 100° C./min and maintaining for one hour. The weight when the temperature reached 430° C. was taken as 100%, and the weight residue ratio after one hour was determined.

[Coefficient of Linear Thermal Expansion (CTE)]

A polyimide film having a film thickness of 10 μm was cut into strips having a width of 4 mm to prepare a test piece. The test piece was heated to 500° C. with a heating rate of 20° C./min using a TMA/SS 6100 (manufactured by SII Nanotechnology Co., Ltd.), with a chuck distance of 15 mm and a tensile load of 2 g. From the obtained TMA curve, the linear thermal expansion coefficient from 100° C. to a predetermined temperature (350° C. to 430° C.) was obtained.

[Retardation in Thickness Direction of Film (Rₜₕ)]

Using a polyimide film having a film thickness of 10 μm and a 5 cm square size as a test piece, and using a retardation measuring device (KOBRA-WR) manufactured by Oji Scientific Instruments Co., Ltd., the retardation of the film was measured with an incident angle of 40°. From the obtained retardation, the retardation in the thickness direction of the film having a thickness of 10 μm was determined.

The abbreviations, purity and the like of the starting materials used in the following examples are as follows.

[Diamine Component]

DABAN: 4,4′-diaminobenzanilide [purity: 99.90% (GC analysis)]
TFMB: 2,2′-bis(trifluoromethyl) benzidine [purity: 99.83% (GC analysis)]
4,4′-ODA: 4,4′-oxydianiline [purity: 99.9% (GC analysis)]
BAPB: 4,4′-bis(4-aminophenoxy) biphenyl
PPD: p-phenylenediamine [purity: 99.9% (GC analysis)]

[Tetracarboxylic Acid Component]

TNDA: tetradecahydro-1H, 3H-4, 12:5,11:6,10-trimethanoanthra [2,3-c:6,7-c′]difuran-1,3,7,9-tetraone
EMDAxx: (3aR, 4R, 5S, 5aS, 8aR, 9R, 10S, 10aS)-decahydro-1H, 3H-4,10-ethano-5,9-methanonaphtho[2,3-c: 6,7-c′]difuran-1,3,6,8-tetraone
PMDA-HS: 1 R, 2 S, 4 S, 5 R-cyclohexanetetracarboxylic dianhydride [purity: 99.9% (GC analysis)]
6 FDA: 4,4′-(2,2-hexafluoroisopropylene)diphthalic dianhydride [purity: 99.77% (H-NMR analysis)]
s-BPDA: 3,3′,4,4′-biphenyltetracarboxylic dianhydride [purity: 99.9% (H-NMR analysis)]

[Solvent]

NMP: N-methyl-2-pyrrolidone

### DMAc: N, N-dimethylacetamide

### Synthesis Example 1 (Synthesis of TNDA)

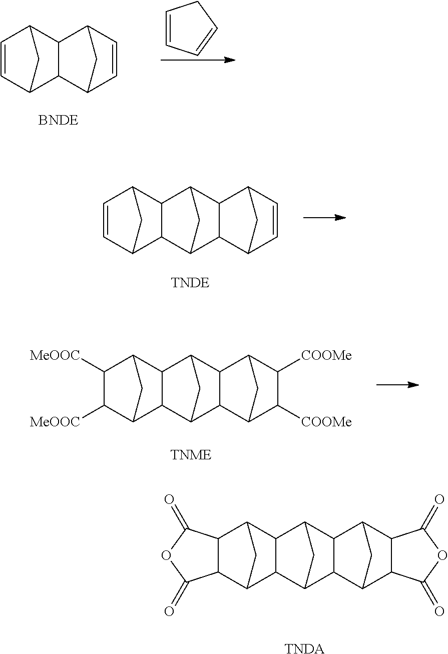

1,4,4a, 5,8,8a-hexahydro-1,4:5,8-dimethanonaphthalene (BNDE) was synthesized by the Diels-Alder reaction of norbornadiene and dicyclopentadiene, with reference to the method described in Macromolecules, 1994, 27, 1117.

To a 200 mL autoclave, 120 g (755.75 mmol) of BNDE and 10 g (75.86 mmol) of dicyclopentadiene were charged. After replacing the inside of the system with nitrogen, the reaction was carried out at a temperature of 180 to 185° C. for 8 hours. After completion of the reaction, 127.5 g of light brown liquid was obtained. The distillation under reduced pressure was carried out under the conditions of a temperature of 87° C., a column top temperature of 73° C. and a degree of vacuum of 1.5 kPa to 0.5 kPa to remove a fraction containing BNDE. 41.2 g of toluene was added to 29.3 g of the residue, and the temperature was raised to 56° C. to dissolve the residue completely. Next, 297 g of methanol was added at the same temperature and then cooled to 50° C. As a result, obtained was a two phase system having a white suspension as the upper layer and a yellow oil as the lower layer. The upper white suspension was taken and concentrated under reduced pressure to obtain 24.03 g of 1,4,4a,5,8,8a, 9,9a,10,10a-decahydro-1,4:5,8:9,10-trimethanoanthracene (TNDE) (purity 94.8 pa % as determined by GC analysis, yield 14.2%).

To a 1 L-capacity reaction vessel, 299 g of methanol, 50 g of chloroform, 200 g (1.48 mol) of copper (II) chloride and 351 mg (1.98 mmol) of palladium chloride were charged and stirred. After replacing the atmosphere in the system with carbon monoxide, a solution of 22 g (93.9 mmol) of TNDE dissolved in 92 g of chloroform was added dropwise over 6.5 hours and allowed to react for 20 hours. After changing the atmosphere in the system from carbon monoxide to argon, the solvent was distilled off from the reaction mixture, and 506 g of chloroform was added. The same operation was further repeated twice. Then, insoluble matter was removed by filtration from the brown-green suspension. The obtained solution was washed with 269 g of saturated aqueous solution of sodium bicarbonate three times and further with 269 g of purified water three times. Then, 2.2 g of anhydrous magnesium sulfate and 2.2 g of activated carbon were added, and stirred. Then, the obtained solution was filtered and concentrated under reduced pressure to obtain 46.63 g of a brown solid. Subsequently, it was purified by recrystallization (solvent ratio; toluene:heptane=1:1.6) and purified by silica gel chromatography (developing solvent; hexane:ethylacetate:chloroform=10:1:1) to obtain 18.39 g of tetramethyl tetradecahydro-1,4-,8:9,10-trimethanoanthracene-2,3,6,7-tetracarboxylate (TNME) as a white solid (purity 97 pa % as determined by HPLC analysis, yield 41.3%).

To a 200 mL-capacity reaction vessel, 18 g (37.9 mmol) of TNME, 53.7 g of formic acid and 146.6 mg (0.77 mmol) of p-toluenesulfonic acid monohydrate were added, and reacted at a temperature of 98° C. to 103° C. for 13 hours. After completion of the reaction, the reaction solution was concentrated under reduced pressure, and 54 g of toluene was added to the concentrate. This operation was repeated 6 times to distill out formic acid almost completely. The obtained suspension was filtered, and the obtained solid was washed with 36 g of toluene and vacuum-dried at 80° C. to obtain 13.28 g of a gray solid. Thereafter, recrystallization with acetic anhydride and recrystallization with N, N′-dimethylacetamide were carried out to obtain 9.87 g of tetradecahydro-1H, 3H-4, 12:5, 11:6,10-trimethanoanthra[2, 3-c: 6,7-c′]difuran-1,3,7,9-tetraone (TNDA) as a white solid (purity 97.4% by ¹H-NMR analysis, yield 68.6%).

### Synthesis Example 2 (Synthesis of EMDAxx)

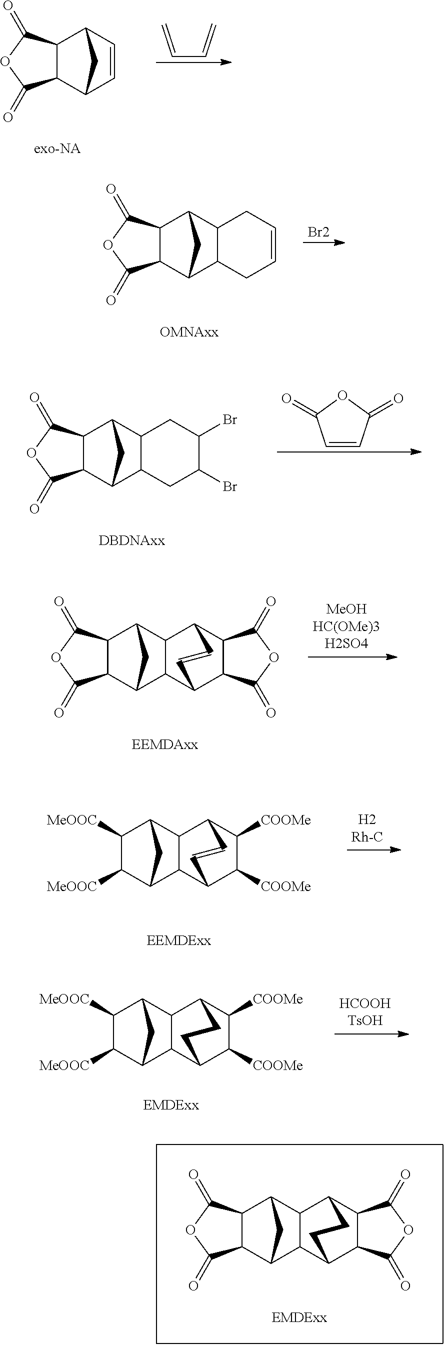

To a 3 L autoclave, 600 g (3.66 mol) of cis-5-norbornene-exo-2,3-dicarboxylic anhydride (exo-NA) and 300 mg of 2,6-dibutylhydroxytoluene were charged. After replacing the inside of the system with nitrogen, 319 g (5.91 mol) of 1,3-butadiene was added at an internal temperature of −25° C., and the mixture was stirred at a reaction temperature of 140 to 166° C. for 35 hours to obtain 866.2 g of a white solid (58% yield). Subsequently, the obtained white solid 866.2 g was recrystallized from toluene to obtain 359 g of (3aR, 4R, 9S, 9aS)-3a, 4,4a, 5,8,8a, 9,9a-octahydro-4, 9-methanonaphtho[2,3-c]furan-1,3-dione (OMNAxx) as a while crystal (purity 100% by ¹H-NMR analysis, yield 45%).

The physical property values of OMNAxx were as follows.

¹H-NMR (CDCl₃, σ (ppm)); 1.19 (d, J=12 Hz, 1H), 1.52-1.63 (m, 2H), 1.73-1.82 (m, 2H), 1.89 (d, J=12 Hz, 1H), 2.27-2.40 (m, 2H), 2.56 (t, J=1.2 Hz, 2H), 2.98 (d, J=1.2 Hz, 2H), 5.80-5.92 (m, 2H) CI-MS (m/z); 219 (M+1)

To a 3 L-capacity reaction vessel, 120 g (550 mmol) of OMNAxx and 2.2 L of dichloromethane were charged. While cooling to a temperature of −65 to −60° C., a solution containing 105.4 g (660 mmol) of bromine dissolved in 200 mL of dichloromethane was added dropwise over 2 hours and allowed to react for 1 hour. This operation was performed twice. The two reaction solutions were collected and concentrated with an evaporator to obtain a light brown solid. 1.5 L of heptane was added to the obtained light brown solid, and filtration was carried out. Subsequently, the collected solid was washed with 500 mL of heptane and then dried in vacuo to obtain (3aR, 4R, 9S, 9aS)-6,7-dibromodecahydro-4,9-methanonaphtho[2,3-c]furan-1,3-dione (DBDNAxx) as a while solid (purity 100% by ¹H-NMR analysis, yield 75%). Further, the filtrate was concentrated under reduced pressure, washed with 500 mL of heptane, and then dried in vacuo obtain 78.1 g of DBDNA xx as a white solid (purity 100% by ¹H-NMR analysis, yield 19%).

Physical properties of DBDNAxx were as follows.

¹H-NMR (CDCl₃, σ (ppm)); 1.28 (d, J=12 Hz, 1H), 1.62 (q, J=12 Hz, 1H), 1.84-2.24 (m, 5H), 2.59 (s, 2H), 3.03 (dd, J=7.3 Hz, J=23 Hz, 2H), 4.32 (ddd, J=3.3 Hz, J=5.5 Hz, J=12 Hz, 1H), 4.73 (dd, J=3.0 Hz, J=7.0 Hz, 1H) CI-MS (m/z); 379 (M+1)

To a 2 L-capacity reaction vessel, 259 g (2.64 mol) of maleic anhydride and 200 g (529 mmol) of DBDNA xx were added and reacted at a reaction temperature of 190° C. for 2 hours. After completion of the reaction, the mixture was cooled to 100° C., and 900 mL of toluene was added. The mixture was cooled to around room temperature, and the precipitated solid was filtered. The obtained solid was washed with 900 mL of toluene and dried under reduced pressure at 60° C. for 3 hours to obtain 140.2 g of (3aR, 4R, 5S, 5aS, 8aR, 9R, 10S, 10aS)-3a, 4, 4a, 5, 5a, 8a, 9,9a,10,10a-decahydro-1H, 3H-4,10-ethano-5,9-methanonaphtho[2,3-c:6,7-c′]difuran-1,3,6,8-tetraone (EEMDAxx) as a light brown solid (purity 97.2% by ¹H-NMR analysis, yield 82%).

In addition, the same operation was carried out on 180 g (476 mmol) of DBDNAxx, to obtain 139.2 g of EEMDAxx as a light brown solid (purity 98.9% by ¹H-NMR, yield 92%).

The physical property values of EEMDAxx were as follows.

¹H-NMR (CDCl₃, σ (ppm)); 0.59 (d, J=12 Hz, 1H), 2.01 (s, 2H), 2.12 (d, J=12 Hz, 1H), 2.55 (s, 2H), 2.98 (d, J=1.4 Hz, 2H), 3.20-3.30 (m, 4H), 6.20 (dd, J=3.1 Hz, J=4.4 Hz, 2H) CI-MS (m/z); 314 (M+1)

To a 20 L-capacity reaction vessel, 254.9 g (794.8 mmol) of EEMDAxx, 10 L of methanol, 533 g of trimethyl orthoformate and 63 g of concentrated sulfuric acid were added, and the mixture was stirred at a temperature of 61 to 67° C. for 79 hours. After completion of the reaction, the reaction solution was concentrated under reduced pressure to obtain 513 g of a gray solid. The obtained solid was dissolved in 3256 g of chloroform and added dropwise to 1700 g of a 7 wt %-sodium hydrogen carbonate aqueous solution. To the separated organic layer, 31.6 g of anhydrous magnesium sulfate and 26.8 g of activated carbon were added, and stirred at room temperature for 1 hour, followed by filtration. The filtrate was washed with 322 g of chloroform and concentrated under reduced pressure to obtain 325 g of a gray solid. Subsequently, the obtained gray solid was recrystallized from methanol to obtain 294.9 g of tetramethyl (1R,4S,5R,6R,7S,8S,10S,11R)-1,4,4a,5,6,7,8,8a-octahydro-1,4-ethano-5,8-methanonaphthalene-6,7,10,11-tetracarboxylate (EEMDExx) as a while solid (purity 100% by GC analysis, yield 91%).

The physical property values of EEMDExx were as follows.

¹H-NMR (CDCl₃, σ (ppm)); 1.55 (d, J=11 Hz, 1H), 1.61 (s, 2H), 2.29 (d, J=11 Hz, 1H), 2.43 (s, 2H), 2.62 (d, J=1.9 Hz, 2H), 2.97 (s, 2H), 3.03 (s, 2H), 3.58 (s, 6H), 3.60 (s, 6H), 6.23 (dd, J=3.2 Hz, J=4.6 Hz, 2H) CI-MS (m/z); 407 (M+1)

To a 3 L autoclave, 98.2 g (242 mmol) of EEMDExx and 1720 g of methanol were charged, and 49.1 g of a 10% rhodium-carbon catalyst (50% water content product made by N.E. CHEMCAT Corporation) was added. After replacing the inside of the system with hydrogen, hydrogen was pressurized to 0.9 MPa, and the reaction was carried out at an internal temperature of 80° C. for 4 hours. After completion of the reaction, the precipitated solid was dissolved using 3235 g of N, N′-dimethylformamide so as to take out the reaction product. The filtration with Celite was carried out to remove the catalyst. This operation was performed twice more on 97.3 g (239 mmol) of EEMDExx. Then, all the filtrates were combined and concentrated under reduced pressure to obtain 289.1 g of a gray solid. Subsequently, the obtained gray solid was recrystallized from 700 g of chloroform and 4373 g of heptane to obtain 283.0 g of tetramethyl (1R,2R, 3S,4S,5R,6R,7S, 8S)-decahydro-1,4-ethano-5,8-methanonaphthalene-2,3,6,7-tetracarboxylate (EMDExx) as a slightly gray solid (purity 99.9 pa % as determined by GC analysis, yield 96%).

The physical property values of EMDExx were as follows.

¹H-NMR (CDCl₃, σ (ppm)); 1.52 (d, J=9.0 Hz, 2H), 1.58 (s, 2H), 1.76 (d, J=9.0 Hz, 2H), 1.95-2.10 (m, 4H), 2.52 (s, 2H), 2.71 (d, J=1.6 Hz, 2H), 2.84 (s, 2H), 3.63 (s, 6H), 3.64 (s, 6H) CI-MS (m/z); 409 (M+1)

To a 3 L-capacity reaction vessel, 282.0 g (689.7 mmol) of EMDExx, 1410 g of formic acid, and 3.28 g (17 mmol) of paratoluenesulfonic acid monohydrate were added and reacted at a temperature of 95° C. to 97° C. for 19 hours. After completion of the reaction, the reaction solution was concentrated under reduced pressure, and 700 mL of toluene was added to the concentrate. This operation was repeated 6 times to distill out formic acid almost completely. The obtained suspension was filtered, and the obtained solid was washed with 490 mL of toluene and vacuum-dried at 80° C. to obtain 219.6 g of a gray solid. Thereafter, recrystallization from acetic anhydride and recrystallization with N, N′-dimethylformamide were carried out to obtain 175.9 g of (3aR,4R,5S,5aS,8aR,9R,10S,10aS)-decahydro-1H, 3H-4,10-ethano-5,9-methanonaphtho[2,3-c:6,7-c′]difuran-1,3,6,8-tetraone (EMDAxx) as a white solid (purity 99.4% by ¹H-NMR analysis, yield 96%).

Further, using 150 g of the obtained EMDAxx, purification was carried out under sublimation conditions of 250 to 290° C./5 Pa to obtain 146 g of EMDAxx as a white solid (purity 100% by ¹H-NMR analysis, recovery rate 97.6%).

Physical property values of EMDAxx were as follows.

¹H-NMR (DMSO-d₆, σ (ppm)); 0.98 (d, J=13 Hz, 1H), 1.15 (d, J=9.4 Hz, 2H), 1.57 (d, J=9.4 Hz, 2H), 1.81 (s, 2H), 1.91 (d, J=13 Hz, 1H), 2.17 (s, 2H), 2.63 (s, 2H), 3.04 (s, 2H), 3.19 (s, 2H) CI-MS (m/z); 317 (M+1)

### Example 1

Into a reaction vessel substituted with nitrogen gas, 0.787 g (3.46 mmol) of DABAN and 0.319 g (0.87 mmol) of BAPB were charged, and 9.620 g of NMP was added so that the total mass of charged monomers (total of diamine component and carboxylic acid component) was 22% by mass, and the mixture was stirred at room temperature for 1 hour. To this solution, 1.607 g (4.36 mmol) of TNDA was gradually added. The mixture was stirred at room temperature for 48 hours to obtain a uniform and viscous polyimide precursor solution.

The polyimide precursor solution filtered with a PTFE membrane filter was applied to a glass substrate and subsequently heated in a nitrogen atmosphere (oxygen concentration: 200 ppm or less) from room temperature to 430° C. on the glass substrate to thermally imidize, whereby a colorless and transparent polyimide film/glass laminate was obtained. Next, the obtained polyimide film/glass laminate was immersed in water to peel the film, and the film was dried to obtain a polyimide film having a film thickness of 10 μm.

Table 1 shows the results of measuring the properties of the polyimide film.

### Example 2

Into a reaction vessel substituted with nitrogen gas, 0.761 g (3.35 mmol) of DABAN and 0.529 g (1.44 mmol) of BAPB were charged, and 8.409 g of NMP was added so that the total mass of charged monomers (total of diamine component and carboxylic acid component) was 25% by mass, and the mixture was stirred at room temperature for 1 hour. To this solution, 1.513 g (4.78 mmol) of EMDAxx was gradually added. The mixture was stirred at room temperature for 48 hours to obtain a uniform and viscous polyimide precursor solution.

The polyimide precursor solution filtered with a PTFE membrane filter was applied to a glass substrate and subsequently heated in a nitrogen atmosphere (oxygen concentration: 200 ppm or less) from room temperature to 430° C. on the glass substrate to thermally imidize, whereby a colorless and transparent polyimide film/glass laminate was obtained. Next, the obtained polyimide film/glass laminate was immersed in water to peel the film, and the film was dried to obtain a polyimide film having a film thickness of 10 μm.

Table 1 shows the results of measuring the properties of the polyimide film.

### Comparative Example 1

Into a reaction vessel substituted with nitrogen gas, 8.000 g (39.95 mmol) of 4,4′-ODA was charged, and 60.117 g of DMAc was added so that the total mass of charged monomers (total of diamine component and carboxylic acid component) was 22% by mass, and the mixture was stirred at room temperature for 1 hour. To this solution, 8.956 g (39.95 mmol) of PMDA-HS was gradually added. The mixture was stirred at room temperature for 48 hours to obtain a uniform and viscous polyimide precursor solution.

The polyimide precursor solution filtered with a PTFE membrane filter was applied to a glass substrate and subsequently heated in a nitrogen atmosphere (oxygen concentration: 200 ppm or less) from room temperature to 400° C. on the glass substrate to thermally imidize, whereby a colorless and transparent polyimide film/glass laminate was obtained. Next, the obtained polyimide film/glass laminate was immersed in water to peel the film, and the film was dried to obtain a polyimide film having a film thickness of 10 μm.

Table 1 shows the results of measuring the properties of the polyimide film.

### Comparative Example 2

Into a reaction vessel substituted with nitrogen gas, 2.00 g (6.25 mmol) of TFMB was charged, and 16.904 g of DMAc was added so that the total mass of charged monomers (total of diamine component and carboxylic acid component) was 21% by mass, and the mixture was stirred at room temperature for 1 hour. To this solution, 1.942 g (4.37 mmol) of 6FDA and 0.551 g (1.87 mmol) of s-BPDA were gradually added. The mixture was stirred at room temperature for 48 hours to obtain a uniform and viscous polyimide precursor solution.

The polyimide precursor solution filtered with a PTFE membrane filter was applied to a glass substrate and subsequently heated in a nitrogen atmosphere (oxygen concentration: 200 ppm or less) from room temperature to 400° C. on the glass substrate to thermally imidize, whereby a colorless and transparent polyimide film/glass laminate was obtained. Next, the obtained polyimide film/glass laminate was immersed in water to peel the film, and the film was dried to obtain a polyimide film having a film thickness of 10 μm.

Table 1 shows the results of measuring the properties of the polyimide film.

### Comparative Example 31

Into a reaction vessel substituted with nitrogen gas, 26.88 g (0.249 mol) of PPD was charged, and 400 g of NMP was added so that the total mass of charged monomers (total of diamine component and carboxylic acid component) was 20% by mass, and the mixture was stirred at room temperature for 1 hour. To this solution, 73.13 g (0.249 mol) of s-BPDA was gradually added. The mixture was stirred at room temperature for 48 hours to obtain a uniform and viscous polyimide precursor solution.

The polyimide precursor solution filtered with a PTFE membrane filter was applied to a glass substrate and subsequently heated in a nitrogen atmosphere (oxygen concentration: 200 ppm or less) from room temperature to 450° C. on the glass substrate to thermally imidize, whereby a colorless and transparent polyimide film/glass laminate was obtained. Next, the obtained polyimide film/glass laminate was immersed in water to peel the film, and the film was dried to obtain a polyimide film having a film thickness of 10 μm.

Table 1 shows the results of measuring the properties of the polyimide film.

TABLE 1

| | | Example | Example | Comp-Ex | Comp-Ex | Comp-Ex |
|---|---|---|---|---|---|---|
| | | 1 | 2 | 1 | 2 | 3 |
| Acid | TNDA | 10 | | | | |
| dianhydride | EMDAxx | | 10 | | | |
| | PMDA-HS | | | 10 | | |
| | 6FDA | | | | 7 | |
| | s-BPDA | | | | 3 | 10 |
| Diamine | DABAN | 8 | 7 | | | |
| | TFMB | | | | 10 | |
| | 4,4′-ODA | | | 10 | | |
| | BAPB | 2 | 3 | | | |
| | PPD | | | | | 10 |

| | | | | | |
|---|---|---|---|---|---|
| Film properties | | | | | |
| YI | 3.9 | 4.6 | 2.2 | 3.4 | 20.2 |
| Transmittance at | 78.1 | 75.7 | 84.5 | 76.5 | 0.3 |
| 400 nm (%) | | | | | |
| Transmittance at | 0.0218 | 0.043 | 52 | 0.002 | 0 |
| 308 nm (%) | | | | | |
| Total light | 86 | 85 | 89 | 88 | 76 |
| transmittance (%) | | | | | |
| Haze (%) | 0.9 | 1.2 | 0.3 | 0.2 | 0.4 |
| Weight residue ratio | 99.36 | 99.36 | 97.55 | 99.74 | — |
| after holding at 400° C. | | | | | |
| 4 h (%) | | | | | |
| Weight residue ratio | 99.37 | 99.19 | 92.51 | 99.64 | >99.0 |
| after holding at 430° C. | | | | | |
| 1 h (%) | | | | | |
| CTE (ppm/K) (100-350° C.) | 40 | 21 | 238 | 58 | 5 |
| CTE (ppm/K) (100-360° C.) | 40 | 22 | 357 | 90 | — |
| CTE (ppm/K) (100-370° C.) | 41 | 22 | 502 | 118 | — |
| CTE (ppm/K) (100-380° C.) | 41 | 22 | — | 138 | — |
| CTE (ppm/K) (100-390° C.) | 42 | 23 | — | — | — |
| CTE (ppm/K) (100-400° C.) | 43 | 23 | 1176 | 171 | 8 |
| CTE (ppm/K) (100-410° C.) | 45 | 25 | — | — | 10 |
| CTE (ppm/K) (100-420° C.) | 50 | 27 | — | — | 12 |
| CTE (ppm/K) (100-430° C.) | 64 | 36 | — | — | 14 |
| Rth (nm) | 129 | 800 | 7 | 98 | 2302 |

CTE: Coefficient of Linear Thermal Expansion
Comp-Ex: Comparative Example,

### INDUSTRIAL APPLICABILITY

According to the present invention, there is provided a polyimide film which can be suitably used for various applications such as a substrate for a display, a touch panel, or a solar cell.

1. A polyimide film comprising polyimide, having:
when measured at a film thickness of 10 μm,
a weight residue ratio of 99.0% or more when held at 400° C. for 4 hours,
a YI (yellow index) of 10 or less,
a coefficient of linear thermal expansion between 100 and 350° C. of 55 ppm/K or less, and
a light transmittance at a wavelength of 308 nm of 0.1% or less.

2. The polyimide film according to claim 1, having weight residue ratio of 99.0% or more when held at 430° C. for 1 hour when measured at a film thickness of 10 μm.

3. The polyimide film according to claim 1, having coefficient of linear thermal expansion between 100 and 380° C. of 65 ppm/K or less when measured at a film thickness of 10 μm.

4. The polyimide film according to claim 1, having haze of 2% or less when measured at a film thickness of 10 μm.

5. The polyimide film according to claim 1, having a retardation in thickness direction (Rth) of 1000 nm or less when measured at a film thickness of 10 μm.

6. (canceled)

7. A laminate, comprising the polyimide film according to claim 1 that has been formed on a glass substrate.

8. A substrate for a display, a touch panel, or a solar cell, comprising the polyimide film according to claim 1.
